(19) United States
(12) Patent Application Publication
(10) Pub. No.: US 2022/0390811 A1
(43) Pub. Date: Dec. 8, 2022

(54) Ultra-low Phase Noise Detection System Generating Millimeter Wave Signal based on Optical Frequency Comb

(71) Applicant: ZHEJIANG UNIVERSITY, Hangzhou (CN)

(72) Inventors: Xiaofeng Jin, Hangzhou (CN); Jichen Qiu, Hangzhou (CN); Ling Yang, Hangzhou (CN); Yafeng Zhu, Hangzhou (CN); Xiangdong Jin, Hangzhou (CN); Xianbin Yu, Hangzhou (CN); Yinfang Xie, Hangzhou (CN)

(21) Appl. No.: 17/566,703

(22) Filed: Dec. 31, 2021

(30) Foreign Application Priority Data
Jun. 7, 2021 (CN) 202110633735.8

(51) Int. Cl. G02F 1/35

(52) U.S. Cl. CPC G02F 1/353; G02F 2203/56

(57) ABSTRACT

The device of the disclosure provides an optical frequency comb frequency multiplication link to generate millimeter wave signals. The device of the disclosure also provides a local oscillator and a delay compensation link to eliminate the influence of the phase noise of the local oscillator on the test system. The local oscillator signal is down-converted in the optical carrier radio frequency link to obtain an intermediate frequency signal. The intermediate frequency signal is then down-converted with the local oscillator signal and the millimeter wave signal twice to cancel the influence of the microwave mixer noise on the test system. At last, by detecting the output low-frequency signal noise, the ultra-low phase noise level of the millimeter wave signal can be accurately obtained.

### CROSS REFERENCE TO RELATED APPLICATIONS

This application claims priority to Chinese Patent Application No. 202110633735.8, filed on Jun. 7, 2021, entitled “Ultra-low Phase Noise Detection System Generating Millimeter Wave Signal based on Optical Frequency Comb”, which is hereby incorporated by reference.

### FIELD OF THE DISCLOSURE

The disclosure relates to the field of optoelectronic technology, and especially relates to an ultra-low phase noise detection system based on an optical frequency comb (OFC) to generate millimeter wave signals.

### BACKGROUND OF THE DISCLOSURE

Phase noise refers to the random fluctuation of the phase of the output signal of the system in a short period of time under the action of various noises in the modern radio frequency system. Phase noise is a key indicator to measure the stability of an electronic radio frequency system. Nowadays, the core device that restricts the quality of electronic systems is the oscillator. As wired and wireless communications, satellite navigation, and accurate measurement require higher and higher phase noise indicators for oscillators, a large number of ultra-low phase noise oscillators have gradually emerged. However, existing commercial phase noise measuring instruments cannot detect ultra-low phase noise. Therefore, it is an urgent problem in the current research field on how to measure signal phase noise quickly and accurately.

Researchers at home and abroad have also conducted in-depth research on phase noise measurement technology in recent decades, and have proposed many phase noise measurement solutions. The direct spectrum analyzer measurement method is the most direct and simple phase noise measurement method. The direct spectrum analyzer measurement method connects the oscillator to be tested directly to the spectrum analyzer, and the phase noise of the oscillator can be calculated from the power spectrum displayed on the instrument. The main drawback of this method is that the phase noise of today's high-stability oscillation sources is often lower than the internal local oscillator source of the instrument. After the oscillator is mixed with the internal local oscillator of the spectrum analyzer, the phase noise of the output intermediate frequency signal will be submerged in the local oscillator. In the vibration phase noise, it is impossible to accurately measure the phase noise information of the oscillator under test. The second method is the beat frequency domain method. First, a frequency multiplier is used to multiply the frequency of the reference signal and the signal to be measured, and then after mixing and low-pass filtering, spectrum analysis of the obtained low-frequency components is performed to obtain the phase noise. The advantage of the beat method is that it has higher sensitivity near the carrier frequency, but it has higher requirements on the reference source and cannot detect high-frequency signals. The third method is the delayed self-homodyne measurement method. The principle is that the source to be measured is divided into two channels. After a certain delay, the signal of one channel is phased with the other channel. After obtaining the low frequency signal, the spectrum analysis is performed, and then the calibration is performed. Can get phase noise. The bottleneck of this technology mainly lies in the high loss of the long electrical delay line, the large size, and the serious electromagnetic interference. At present, the most widely used and highly sensitive measurement technique is still the phase detection method. The structure of the phase discrimination method first uses a phase-locked loop circuit to maintain the phase quadrature between the two signals, then mix the local oscillator reference signal with the measured signal, and then use a low-pass filter to filter out the low-frequency components containing the phase fluctuations between the signals, thereby obtaining the phase noise of the signal. The main limitation of the phase detection method is that the local oscillator source is required to be in quadrature with the phase of the signal under test, and the phase noise of the reference source is lower than that of the oscillator under test, so it is not suitable for measuring low phase noise oscillators.

With the rapid development of microwave photonics, a brand new method is provided for the generation of microwave sources and the measurement of phase noise. Microwave photonic links can convert microwave signals into electrical signals, and then restore them to microwave signals after being delayed by optical fiber and other devices, finally realizing low-loss and high-stability signal delay. Compared with the loss of coaxial cable at X-band as high as 1.8 dB/m, the loss at 1550 nm with single-mode fiber is only 0.2 dB/km. In addition, the microwave photonic link has a lower system noise floor, and the high-stability oscillation source to be tested will not be affected. Compared with the traditional frequency discrimination method, which has high requirements for the quality of the local oscillator signal, the phase noise measurement method using microwave photonic technology can reduce the dependence on the local oscillator reference source, further improve the sensitivity of phase noise detection, and has a wider applicability.

### SUMMARY OF THE DISCLOSURE

In view of the above, the present invention provides an ultra-low phase noise detection technology based on optical frequency combs to generate millimeter wave signals, which can detect the phase noise of millimeter wave oscillation signals with low phase noise.

An ultra-low phase noise detection system generating millimeter wave signals based on optical frequency comb is provided. The ultra-low phase noise detection system comprises an OFC (Optical Frequency Comb) generator, an optical coupler, a millimeter wave N-multiplier signal generation link, an OFC n-multiplier loop, an optical carrier radio frequency transmission link, a local oscillator and delay compensation link, a first microwave mixer, and a second microwave mixer; the OFC generator is divided into two paths through the optical coupler, one OFC signal passes through the n-multiplier loop, and is down-converted with a local oscillator signal in the optical carrier radio frequency transmission link to generate an intermediate frequency signal, and the other OFC signal passes through the millimeter wave N-multiplier signal generation link to generate a millimeter wave signal; after passing the delay compensation link, the local oscillator signal is down-converted with the intermediate frequency signal in the first microwave mixer; a first output signal of the first microwave mixer is down-converted with the millimeter wave signal in the second microwave mixer to obtain a second output signal.

By measuring the phase noise of the output low-frequency signal by a spectrum analyzer, the ultra-low phase noise of the high-frequency millimeter wave signal generated by the N-multiplier link, which cannot be directly measured, can be calculated and obtained.

The optical carrier radio frequency transmission link comprises an electro-optical modulator, a first photodetector, and an IF (Intermediate Frequency) band pass filter. The electro-optical modulator is configured to modulate a n-multiplied OFC signal with the local oscillator signal and output an intensity-modulated optical signal. The first photodetector is configured to receive the intensity-modulated optical signal and beat the intensity-modulated optical signal to obtain an electrical signal. The IF band pass filter, which is configured to band-pass filter the electrical signal output by the first photodetector, wherein a center frequency of the IF band pass filter is equal to the frequency difference between the local oscillator signal and the millimeter wave signal generated by the N-multiplier link.

In some embodiments, the local oscillator and delay compensation link comprises: a local oscillator signal source and a local oscillator delay compensation. The local oscillator signal source is configured to generate a stable sinusoidal signal with a frequency equal to the frequency difference between the millimeter wave signal and the center frequency of the IF band pass filter. The local oscillator delay compensation is configured to generate a time delay to the local oscillator signal to compensate for a group delay in the optical carrier radio frequency link.

In some embodiments, the n-multiplier loop of the OFC is composed of optical fiber delay lines connected in sequence on multiple stages. Two adjacent stages of optical fiber delay lines are connected by a 2×2 optical coupler. The optical fiber delay line on each stage is consisted of an upper optical fiber and a lower optical fiber having a delay difference to the upper optical fiber. The upper optical fiber and the lower optical fiber are connected to the optical fiber delay lines in the next stage.

The stages of the optical fiber delay lines in the OFC n-multiplier loop are determined by the multiplication factor n, and n is a natural number greater than 1; if log₂n is a positive integer, the multiplier loop comprises log₂n stages of optical fiber lines, and the delay difference between the upper optical fiber and the lower optical fiber of the optical fiber delay line on the ith stage is Δτ/2ⁱ, where i is a natural number, 1≤i≤log₂n; if log₂n is not positive integer, the multiplier loop comprises ┌log₂ n┐ stages of optical fiber delay lines, and the delay difference between the upper optical fiber and the lower optical fiber of the optical fiber delay line on the ith stage is

$$\frac{{2}^{[ {log}_{2} n ] - ( i - 1 )} Δ τ}{n} ,$$

1≤i≤┌log₂ n┐, where ┌ ┐ is the round-up operator, and Δτ is the basic frequency interval of the OFC signal.

In some embodiments, the millimeter wave N-multiplier signal generation link comprises a second photodetector, and an OFC N-multiplier loop. The second photodetector is configured to convert the N-multiplied optical signal of the OFC into the millimeter wave signal.

The OFC N-multiplier loop is consisted of multiple stages of optical fiber delay lines connected in sequence, and the optical fiber delay lines on adjacent two stages are connected by the 2×2 optical coupler; the optical fiber delay line on each stage is consisted of an upper optical fiber and a lower optical fiber having a delay difference to the upper optical fiber; the upper optical fiber and the lower optical fiber are connected to the optical fiber delay lines in the next stage.

The stages of the optical fiber delay lines in the OFC N-multiplier loop are determined by the multiplication factor N, and N is a natural number far greater than 1; if log₂N is a positive integer, the multiplier loop comprises log₂N stages of optical fiber lines, and the delay difference between the upper optical fiber and the lower optical fiber of the optical fiber delay line on the kth stage is Δτ/2^{k}, where k is a natural number, 1≤k≤log₂N; if log₂N is not positive integer, the multiplier loop comprises tog, Ni stages of optical fiber delay lines, and the delay difference between the upper optical fiber and the lower optical fiber of the optical fiber delay line on the ith stage is

$$\frac{{2}^{[ {log}_{2} N ] - ( k - 1 )} Δ τ}{N} ,$$

1≤k≤┌log₂N┐, where ┌ ┐ is the round-up operator, and Δτ is the basic frequency interval of the OFC signal.

In some embodiments, the first microwave mixer is configured to mix the local oscillator signal after delay compensation with the intermediate frequency signal output by the optical carrier radio frequency transmission link.

The second microwave mixer is configured to mix the millimeter wave signal with the output signal of the first microwave mixer.

The system of the present disclosure uses the N-multiplier link of the OFC to generate millimeter wave signals, and has the local oscillator and the delay compensation link to eliminate the influence of the phase noise of the local oscillator on the test system. The local oscillator signal is down-converted in the optical carrier radio frequency link to obtain an intermediate frequency signal. The intermediate frequency signal is then down-converted with the local oscillator signal and the millimeter wave signal twice to cancel the influence of the microwave mixer noise on the test system. At last, by detecting the output low-frequency signal noise, the ultra-low phase noise level, which cannot be directly measured, by the millimeter wave signal can be accurately calculated and obtained. Accordingly, the system of the present disclosure can provide phase noise detection with ultra-low noise floor for high-quality and stable oscillation sources such as photoelectric oscillators and optical frequency clocks.

### BRIEF DESCRIPTION OF DRAWINGS

FIG. 1 is a schematic diagram of the detection system.

FIG. 2 is a schematic diagram of the OFC n-multiplier loop of the detection system.

FIG. 3 is a schematic diagram of the millimeter wave N-multiplier signal generation link of the detection system.

FIG. 4 is a block diagram of the S-domain phase noise expression derivation of the detection system.

In the drawings: 1-OFC generator; 2-1×2 optical coupler; 3-millimeter wave N-multiplier signal generation link; 4-OFC n-multiplier loop; 5-optical carrier RF transmission link; 6-first microwave mixer; 7-local oscillator and delay compensation link; 8-second microwave mixer.

### DETAILED DESCRIPTION OF THE DISCLOSURE

In order to describe the present disclosure in detail, the present disclosure will be described in detail below with reference to the accompanying drawings and specific embodiments.

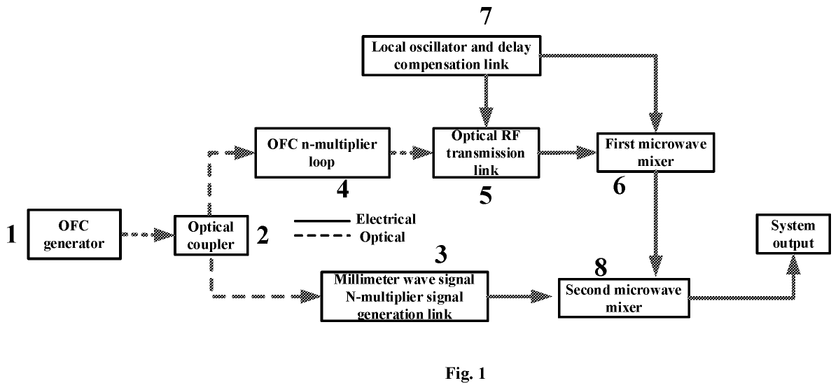

Referring to FIG. 1, an ultra-low phase noise detection system generating millimeter wave signals based on OFC is provided. The ultra-low phase noise detection system comprises an OFC generator 1, an optical coupler 2, a millimeter wave N-multiplier signal generation link 3, an OFC n-multiplier loop 4, an optical carrier radio frequency transmission link, a local oscillator and delay compensation link 7, a first microwave mixer 6, and a second microwave mixer 8. The OFC generator 1 is divided into two paths through the optical coupler 2, one OFC signal passes through the n-multiplier loop, and is down-converted with a local oscillator signal in the optical carrier radio frequency transmission link to generate an intermediate frequency signal, and the other OFC signal passes through the millimeter wave N-multiplier signal generation link 3 to generate a millimeter wave signal; after passing the delay compensation link, the local oscillator signal is down-converted with the intermediate frequency signal in the first microwave mixer 6; a first output signal of the first microwave mixer 6 is down-converted with the millimeter wave signal in the second microwave mixer 8 to obtain a second output signal. By measuring the phase noise of the output low-frequency signal by a spectrum analyzer, the ultra-low phase noise of the high-frequency millimeter wave signal generated by the N-multiplier link, which cannot be directly measured, can be calculated and obtained.

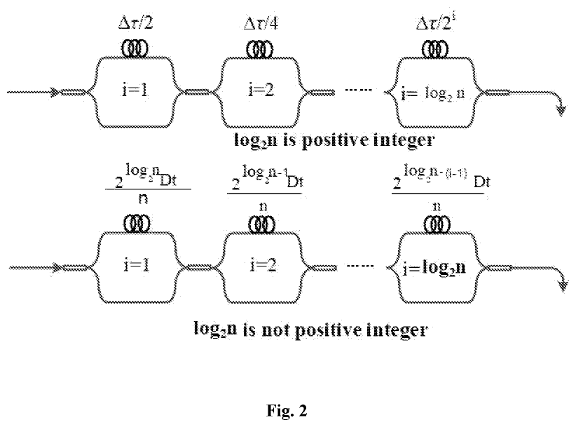

Referring to FIG. 2, the n-multiplier loop of the OFC is composed of optical fiber delay lines connected in sequence on multiple stages. Two adjacent stages of optical fiber delay lines are connected by a 2×2 optical coupler. The optical fiber delay line on each stage is consisted of an upper optical fiber and a lower optical fiber having a delay difference to the upper optical fiber. The upper optical fiber and the lower optical fiber are connected to the optical fiber delay lines in the next stage. The stages of the optical fiber delay lines in the OFC n-multiplier loop 4 are determined by the multiplication factor n, and n is a natural number greater than 1; if log₂n is a positive integer, the multiplier loop comprises log₂n stages of optical fiber lines, and the delay difference between the upper optical fiber and the lower optical fiber of the optical fiber delay line on the ith stage is Δτ/2ⁱ, where i is a natural number, 1≤i≤log₂n; if log₂n is not positive integer, the multiplier loop comprises ┌log₂N┐ stages of optical fiber delay lines, and the delay difference between the upper optical fiber and the lower optical fiber of the optical fiber delay line on the ith stage is

$$\frac{{2}^{[ {log}_{2} n ] - ( i - 1 )} Δ τ}{n} ,$$

1≤i≤┌log₂ n┐, where ┌ ┐ is the round-up operator, and Δτ is the basic frequency interval of the OFC signal. The n-multiplied OFC signal is transmitted to the optical carrier radio frequency transmission link.

The optical carrier radio frequency transmission link comprises an electro-optical modulator, a first photodetector, and an IF band pass filter. The electro-optical modulator is configured to modulate a n-multiplied OFC signal with the local oscillator signal and output an intensity-modulated optical signal, as shown in the formula (1) as follows, where β is the modulation depth, which is determined by the DC bias voltage applied to the intensity modulator; ω_{L}, φ_{L}, are the frequency and phase noise of the local oscillator signal respectively; A₀ is the amplitude of the OFC; ω₀ is the fundamental frequency of the OFC; τ_{O} is the time jitter introduced by the OFC.

$${I}_{M Z M} = [ 1 + β cos ( {ω}_{L} t + {φ}_{L} ) ] {\sum }_{i = 0}^{∞} {A}_{O} δ ( t - \frac{2 π i}{n {ω}_{0}} - {τ}_{O} ) \qquad ( 1 )$$

The first photodetector is configured to receive the intensity-modulated optical signal and beat the intensity-modulated optical signal to obtain an electrical signal. The IF band pass filter is configured to band-pass filter the electrical signal output by the first photodetector. The center frequency signal outputted by the IF band pass filter is shown in the formula (2) as follows. The center frequency of the IF band pass filter is equal to the frequency difference between the local oscillator signal and the millimeter wave signal generated by the N-multiplier link. Where, CO_{IF} is the center frequency of the intermediate frequency filter; τ_{A-P}, (A_{O}) is the time jitter caused by the intensity-phase effect caused by the excessive OFC intensity during the photoelectric conversion process; φ_{IBPF} is the phase noise introduced by the intermediate frequency filter, and co, is the phase noise of the local oscillator signal.

V_{IF}=βA_{O}(ω_{IF}t+nω₀τ_{O}−ω_{IF}τ_{A-P}(A_{O})+φ_{L}+φ_{IBPF}) (2)

In this embodiment, the local oscillator and delay compensation link 7 comprises a local oscillator signal source and a local oscillator delay compensation. The local oscillator signal source is configured to generate a stable sinusoidal signal with a frequency equal to the frequency difference between the millimeter wave signal and the center frequency of the IF band pass filter, and the generated stable sinusoidal signal is transmitted to the RF port of the electro-optical modulator through SMA wire. The local oscillator delay compensation is configured to generate a time delay to the local oscillator signal and the delay compensated signal is transmitted to LO port of the first microwave mixer 6 for compensating a group delay in the optical carrier radio frequency link, thereby eliminating the influence of the phase noise of the local oscillator on the system output. The first microwave mixer 6 is configured to mix the intermediate frequency signal with the local oscillator signal after delay compensation, and the expression of the output radio frequency signal is:

ν_{RF}≈βA₁ cos[(Nω₀−2ω_{IF})t−ω_{L}Δt+φ_{L}(t−Δt)−φ_{L}(t)+ω_{IF}τ_{AM-PM}(A₁)+φₘᵢₓ₁+φ_{IBPF}] (3)

Where, Δt is the group delay difference between the delay compensation link and the optical carrier RF link 5, and φ_{IBPF} is the phase noise of the IF filter.

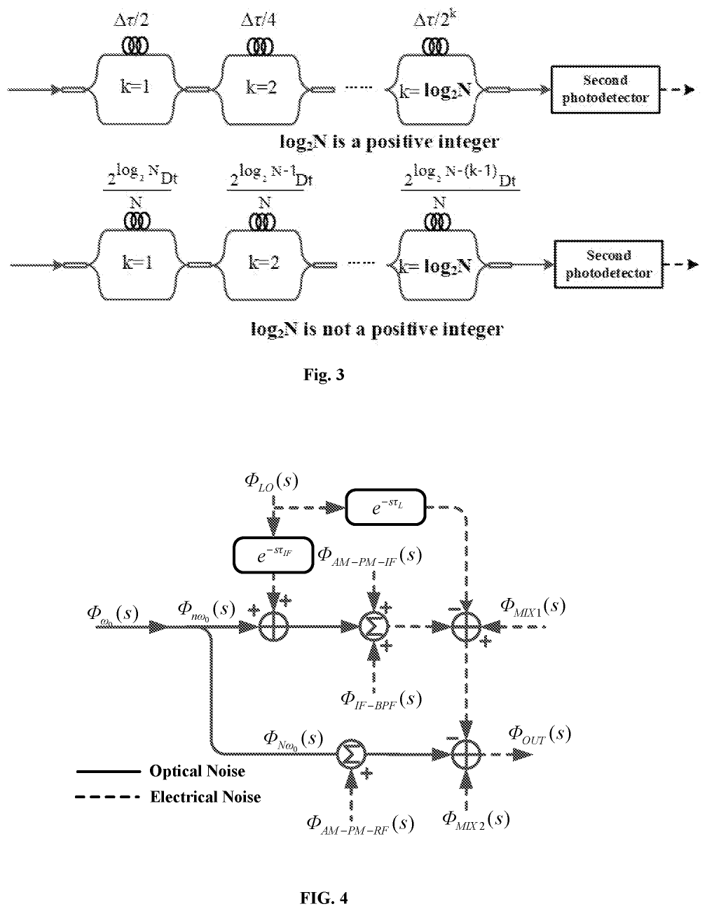

Referring to FIG. 3, the millimeter wave N-multiplier signal generation link 3 comprises a second photodetector and an OFC n-multiplier loop 4. The OFC N-multiplier loop is consisted of multiple stages of optical fiber delay lines connected in sequence, and the optical fiber delay lines on adjacent two stages are connected by the 2×2 optical coupler. The optical fiber delay line on each stage is consisted of an upper optical fiber and a lower optical fiber having a delay difference to the upper optical fiber. The upper optical fiber and the lower optical fiber are connected to the optical fiber delay lines in the next stage. The stages of the optical fiber delay lines in the OFC n-multiplier loop 4 are determined by the multiplication factor N, and N is a natural number far greater than 1. If log₂N is a positive integer, the multiplier loop comprises log₂N stages of optical fiber lines, and the delay difference between the upper optical fiber and the lower optical fiber of the optical fiber delay line on the kth stage is Δτ/2^{k}, where k is a natural number, 1≤k≤log₂N. If log₂N is not positive integer, the multiplier loop comprises ┌log₂N┐ stages of optical fiber delay lines, and the delay difference between the upper optical fiber and the lower optical fiber of the optical fiber delay line on the ith stage is

$$\frac{{2}^{[ {log}_{2} N ] - ( k - 1 )} Δ τ}{N} ,$$

1≤k≤┌Log₂N┐, where ┌ ┐ is the round-up operator, and Δτ is the basic frequency interval of the OFC signal. The OFC signal which is N-multiplied is transmitted to the second photodetector through the fiber, and the OFC N-multiplied optical signal is converted into the millimeter wave signal.

The second microwave mixer 8 is configured to down-convert the radio frequency signal output by the first microwave mixer 6 and the millimeter wave signal output by the second photodetector, and the output signal is as follows:

νₒᵤₜ=A₃ cos[2ω_{IF}t+φ_{L}(t−Δt)−φ_{L}−ω_{IF}τ_{A-P}(A₁)+ω_{RF}τ_{A-P}(A₁)+Nω₀τ₀−nω₀τ₀−φₘᵢₓ₁−φₘᵢₓ₂] (4)

Where, φₘₐₓ₁ and φₘₐₓ₂ are the phase noise of the first microwave mixer 6 and the second microwave mixer 8, respectively.

Converting formula (4) in the time domain to the frequency domain as follows, and the phase noise expression of the output signal can be obtained.

$${L}_{ψ} ( f ) = {L}_{millimeter wave signal} ( f ) + \frac{( {S}_{ψ mix 2} ( f ) - {S}_{ψ mix 1} ( f ) )}{2} - \frac{{S}_{IF - A - P}}{2} + 2 {sin}^{2} ( π f \cdot Δ t ) \cdot {L}_{ψ LO} ( f ) - \frac{{S}_{ψ IFBPF} ( f )}{2} ( dB c / Hz ) \qquad ( 5 )$$

Where, S_{ψmix1}(f) and S_{ψmix1}(f) are the noise spectrum of the first microwave mixer 6 and the second microwave mixer 8, respectively; S_{ψIFBPF} (f) is the noise spectrum of the IF filter; L_{ΨLO} (f) is the noise spectrum of the local oscillator signal; S_{IF-A-P} (f) is the noise spectrum of the first photodetector under the condition of specific input light intensity. When the delay compensation is adjusted appropriately, there may be Δt=0. Furthermore, when the first microwave mixer 6 and the second microwave mixer 8 are the same, the noise spectrum of the two is equal, and formula (5) can be further simplified as follows:

$${L}_{ψ} ( f ) = {L}_{millimeter wave signal} ( f ) - \frac{{S}_{IF - A - P} ( f )}{2} - \frac{{S}_{ψ IFBPF} ( f )}{2} ( dB c / Hz ) \qquad ( 6 )$$

The phase noise of the output signal in formula (6), the noise spectrum of the intermediate frequency filter, and the noise spectrum of the first photodetector can all be measured directly, so the present disclosure can accurately calculate the phase noise of the high-stability millimeter wave signal.

The above is only the preferred implementation mode of the present disclosure. It should be noted that for ordinary technicians in the technical field, without deviating from the principles of the disclosure, a number of improvements and refinements may be made, which shall also be considered as the scope of protection of the present disclosure.

What is claimed is:

1. An ultra-low phase noise detection system generating millimeter wave signals based on optical frequency comb, comprising:
an OFC (optical frequency comb) generator,
an optical coupler,
a millimeter wave N-multiplier signal generation link,
an OFC n-multiplier loop,
an optical carrier RF (radio frequency) transmission link,
a local oscillator and delay compensation link,
a first microwave mixer, and
a second microwave mixer;
the OFC generator is divided into two paths through the optical coupler, one OFC signal passes through the n-multiplier loop, and is down-converted with a local oscillator signal in the optical carrier radio frequency transmission link to generate an intermediate frequency signal, and the other OFC signal passes through the millimeter wave N-multiplier signal generation link to generate a millimeter wave signal; after passing the delay compensation link, the local oscillator signal is down-converted with the intermediate frequency signal in the first microwave mixer; a first output signal of the first microwave mixer is down-converted with the millimeter wave signal in the second microwave mixer to obtain a second output signal.

2. The system according to claim 1, wherein the optical carrier radio frequency transmission link comprises:
an electro-optical modulator, which is configured to modulate a n-multiplied OFC signal with the local oscillator signal, and output an intensity-modulated optical signal;
a first photodetector, which is configured to receive the intensity-modulated optical signal and beat the intensity-modulated optical signal to obtain an electrical signal; and
an IF band pass filter, which is configured to band-pass filter the electrical signal output by the first photodetector, wherein a center frequency of the IF band pass filter is equal to the frequency difference between the local oscillator signal and the millimeter wave signal generated by the N-multiplier link.

3. The system according to claim 1, wherein the local oscillator and delay compensation link comprises:
a local oscillator signal source, which is configured to generate a stable sinusoidal signal with a frequency equal to the frequency difference between the millimeter wave signal and the center frequency of the IF band pass filter;
a local oscillator delay compensation, which is configured to generate a time delay to the local oscillator signal to compensate for a group delay in the optical carrier radio frequency link.

4. The system according to claim 1, wherein the n-multiplier loop of the OFC is composed of optical fiber delay lines connected in sequence on multiple stages; two adjacent stages of optical fiber delay lines are connected by a 2×2 optical coupler; the optical fiber delay line on each stage is consisted of an upper optical fiber and a lower optical fiber having a delay difference to the upper optical fiber; the upper optical fiber and the lower optical fiber are connected to the optical fiber delay lines in the next stage;
the stages of the optical fiber delay lines in the OFC n-multiplier loop are determined by the multiplication factor n, and n is a natural number greater than 1; if log₂n is a positive integer, the multiplier loop comprises log₂n stages of optical fiber lines, and the delay difference between the upper optical fiber and the lower optical fiber of the optical fiber delay line on the ith stage is Δτ/2ⁱ, where i is a natural number, 1≤i≤log₂n; if log₂n is not positive integer, the multiplier loop comprises ┌log₂ n┐ stages of optical fiber delay lines, and the delay difference between the upper optical fiber and the lower optical fiber of the optical fiber delay line on the ith stage is
$$\frac{{2}^{[ {log}_{2} n ] - ( i - 1 )} Δ τ}{n} ,$$
1≤i≤┌log₂ n┐, where ┌ ┐ is the round-up operator, and Δτ is the basic frequency interval of the OFC signal.

5. The system according to claim 1, wherein the millimeter wave N-multiplier signal generation link comprises:
a second photodetector, configured to convert the N-multiplied optical signal of the OFC into the millimeter wave signal;
an OFC N-multiplier loop, which is consisted of multiple stages of optical fiber delay lines connected in sequence, and the optical fiber delay lines on adjacent two stages are connected by the 2×2 optical coupler; the optical fiber delay line on each stage is consisted of an upper optical fiber and a lower optical fiber having a delay difference to the upper optical fiber; the upper optical fiber and the lower optical fiber are connected to the optical fiber delay lines in the next stage;
the stages of the optical fiber delay lines in the OFC N-multiplier loop are determined by the multiplication factor N, and N is a natural number far greater than 1; if log₂N is a positive integer, the multiplier loop comprises log₂N stages of optical fiber lines, and the delay difference between the upper optical fiber and the lower optical fiber of the optical fiber delay line on the kth stage is Δτ/2^{k}, where k is a natural number, 1≤k≤log₂N; if log₂N is not positive integer, the multiplier loop comprises ┌log₂N┐ stages of optical fiber delay lines, and the delay difference between the upper optical fiber and the lower optical fiber of the optical fiber delay line on the ith stage is
$$\frac{{2}^{[ {log}_{2} N ] - ( k - 1 )} Δ τ}{N} ,$$
1≤k≤┌log₂N┐, where ┌ ┐ is the round-up operator, and Δτ is the basic frequency interval of the OFC signal.

6. The system according to claim 1, wherein
the first microwave mixer is configured to mix the local oscillator signal after delay compensation with the intermediate frequency signal output by the optical carrier radio frequency transmission link;
the second microwave mixer is configured to mix the millimeter wave signal with the output signal of the first microwave mixer.
